(19) United States
(12) Patent Application Publication
(10) Pub. No.: US 2020/0157328 A1
(43) Pub. Date: May 21, 2020

(54) Polyalphaolefin Modified Polymer Blends for Nonwovens

(71) Applicant: ExxonMobil Chemical Patents Inc., Baytown, TX (US)

(72) Inventors: Paul E. Rollin, JR., Porter, TX (US); John W. M. Roberts, Houston, TX (US); Jessica L. Prince, Somerville, NJ (US); Syamal Tallury, Houston, TX (US); Narayanaswami Dharmarajan, Houston, TX (US); Andrew V. Stephens, Houston, TX (US); Louis K. Apraku-Boadi, Houston, TX (US)

(21) Appl. No.: 16/667,381

(22) Filed: Oct. 29, 2019

Related U.S. Application Data
(60) Provisional application No. 62/768,612, filed on Nov. 16, 2018.

(51) Int. Cl. C08L 23/12; D01F 1/10; D04H 3/007; D01F 6/46

(52) U.S. Cl. CPC C08L 23/12; D01F 1/10; D04H 3/007; D10B 2321/022; C08L 2203/12; C08L 2205/025; C08L 2205/03; D01F 6/46

(57) ABSTRACT

A fiber or nonwoven and methods for making and using same are provided herein. The fiber or nonwoven can contain at least one primary polypropylene, at least one polyalphaolefin, and at least one propylene-based elastomer. The propylene-based elastomer can have a heat of fusion less than about 80 J/g. The propylene-based elastomer can also include greater than 50 wt % propylene and from about 3 to about 25 wt % units derived from one or more C₂ or C₄-C₁₂ α-olefins, based on a total weight of the propylene-based elastomer.

### CROSS-REFERENCE TO RELATED APPLICATIONS

This application claims priority to U.S. Ser. No. 62/768,612, filed Nov. 16, 2018, herein incorporated by reference.

### FIELD OF THE INVENTION

Embodiments described generally relate to polymer blends for nonwovens and methods for making and using same.

### BACKGROUND

The use of propylene-based polymers and copolymers (sometimes referred to as propylene-based elastomers) for the manufacture of nonwoven fabrics is well known in the art. Such fabrics have a wide variety of uses, such as in medical and hygiene products, clothing, filter media, and sorbent products. Nonwoven fabrics are particularly useful in hygiene products, such as baby diapers, adult incontinence products, and feminine hygiene products. An important aspect of these fabrics is the ability to produce fabrics that have a similar “softness” to fabrics produced from natural fibers.

Nonwoven fabrics often lack the desired soft feel of natural fibers and fabrics. The soft feeling in natural fibers is due to the space-filling characteristic of natural fibers. Natural fibers have a three-dimension structure that allows for space in the material that gives a bounce or soft feeling. However, synthetic fibers are usually flat and therefore lack the soft feel of natural fibers. Several mechanical treatments have been used to impart “softness” to synthetic fibers or fabrics, including crimping, air jet texturing, or pleating. However, these methods are not easily applicable to nonwoven fabrics in cost-effective ways.

There is a need, therefore, for a nonwoven fabric that can be produced economically and increases the “softness” of the fabric. The method should be simple and be suitable for fabric preparation at high production rates typically used on current state-of-the-art spunbond production equipment.

### SUMMARY OF THE INVENTION

Fibers and nonwovens and methods for making and using those materials are provided herein. In some examples, the fibers and nonwovens can include at least one primary polypropylene, at least one polyalphaolefin, and at least one propylene-based elastomer. The propylene-based elastomer can have a heat of fusion less than about 80 J/g. The propylene-based elastomer can also include greater than 50 wt % propylene and from about 3 to about 25 wt % units derived from one or more C₂ or C₄-C₁₂ α-olefins, based on a total weight of the propylene-based elastomer.

### DETAILED DESCRIPTION OF THE INVENTION

It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat various exemplary embodiments herein. This repetition is for the purpose of simplicity and clarity and does not in itself dictate a relationship between the various exemplary embodiments and/or configurations. Moreover, the formation of a first feature over or on a second feature in the description that follows may include embodiments in which the first and second features are formed in direct contact and may also include embodiments in which additional features may be formed interposing the first and second features, such that the first and second features may not be in direct contact. Finally, the exemplary embodiments presented below may be combined in any combination of ways, i.e., any element from one exemplary embodiment may be used in any other exemplary embodiment, without departing from the scope of the disclosure.

Additionally, certain terms are used throughout the following description and claims to refer to components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Additionally, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope. Furthermore, as it is used in the claims or specification, the term “or” is intended to encompass both exclusive and inclusive cases, i.e., “A or B” is intended to be synonymous with “at least one of A and B,” unless otherwise expressly specified herein.

Fibers, nonwoven fabrics, and other nonwoven articles comprising a blend of at least one polyalphaolefins (PAO), at least one propylene-based elastomer, and at least one primary propylene are provided herein, as well as methods for forming the same.

As used herein, the term “copolymer” is meant to include polymers having two or more monomers, optionally with other monomers, and may refer to interpolymers, terpolymers, etc. The term “polymer” as used herein includes, but is not limited to, homopolymers, copolymers, terpolymers, etc., and alloys and blends thereof. The term “polymer” as used herein also includes impact, block, graft, random, and alternating copolymers. The term “polymer” shall further include all possible geometrical configurations unless otherwise specifically stated. Such configurations may include isotactic, syndiotactic and random symmetries. The term “blend” as used herein refers to a mixture of two or more polymers. The term “elastomer” shall mean any polymer exhibiting some degree of elasticity, where elasticity is the ability of a material that has been deformed by a force (such as by stretching) to return at least partially to its original dimensions once the force has been removed. All molecular weights (Mw, Mn, and Mz) can be determined using a gel permeation chromatography (GPC).

The term “monomer” or “comonomer” as used herein can refer to the monomer used to form the polymer, i.e., the unreacted chemical compound in the form prior to polymerization, and can also refer to the monomer after it has been incorporated into the polymer, also referred to herein as a “[monomer]-derived unit”, which by virtue of the polymerization reaction typically has fewer hydrogen atoms than it does prior to the polymerization reaction. Different monomers are discussed herein, including propylene monomers, ethylene monomers, and diene monomers.

“Polypropylene” as used herein includes homopolymers and copolymers of propylene or mixtures thereof. Products that include one or more propylene monomers polymerized with one or more additional monomers may be more commonly known as random copolymers (RCP) or impact copolymers (ICP). Impact copolymers may also be known in the art as heterophasic copolymers. “Propylene-based,” as used herein, is meant to include any polymer comprising propylene, either alone or in combination with one or more comonomers, in which propylene is the major component (i.e., greater than 50 wt % propylene).

“Primary polypropylene” as used herein refers to a propylene homopolymer, or a copolymer of propylene, or some mixture of propylene homopolymers and copolymers.

“Reactor grade” as used herein means a polymer that has not been chemically or mechanically treated or blended after polymerization in an effort to alter the polymer's average molecular weight, molecular weight distribution, or viscosity. Particularly excluded from those polymers described as reactor grade are those that have been visbroken or otherwise treated or coated with peroxide. For the purposes of this disclosure, however, reactor grade polymers include those polymers that are reactor blends.

“Reactor blend” as used herein means a highly dispersed and mechanically inseparable blend of two or more polymers produced in situ as the result of sequential or parallel polymerization of one or more monomers with the formation of one polymer in the presence of another, or by solution blending polymers made separately in parallel reactors. Reactor blends may be produced in a single reactor, a series of reactors, or parallel reactors and are reactor grade blends. Reactor blends may be produced by any polymerization method, including batch, semi-continuous, or continuous systems. Particularly excluded from “reactor blend” polymers comprising a blend of two or more polymers in which the polymers are blended ex situ, such as by physically or mechanically blending in a mixer, extruder, or other similar device.

### Primary Polypropylene

The primary polypropylene can be predominately crystalline, as evidenced by having a melting point generally greater than 110° C., greater than 115° C., and greater than 130° C., or within a range from 110°, or 115°, or 130° C. to 150°, or 160°, or 170° C. The term “crystalline,” as used herein, characterizes those polymers which possess high degrees of inter- and intra-molecular order. The polypropylene can have a heat of fusion at least 60 J/g, at least 70 J/g, or at least 80 J/g, as determined by DSC analysis. The heat of fusion can be dependent on the composition of the polypropylene. A polypropylene homopolymer can have a higher heat of fusion than copolymer or blend of homopolymer and copolymer. Determination of this heat of fusion can be influenced by treatment of the sample.

The primary polypropylene can vary widely in structural composition. For example, substantially isotactic polypropylene homopolymer or propylene copolymer containing equal to or less than 9 wt % of other monomers, that is, at least 90 wt % propylene, can be used. Further, the primary polypropylene can be present in the form of a graft or block copolymer, in which the blocks of polypropylene have substantially the same stereoregularity as the propylene-α-olefin copolymer so long as the graft or block copolymer has a sharp melting point above 110° C., and above 115° C., and above 130° C., characteristic of the stereoregular propylene sequences. The primary polypropylene can be a combination of homopolymer propylene, and/or random, and/or block copolymers as described herein. When the above primary polypropylene is a random copolymer, the percentage of the copolymerized α-olefin in the copolymer can be, in general, up to 9 wt % by weight of the polypropylene, between 0.5 wt % to 8 wt % by weight of the polypropylene, or between 2 wt % to 6 wt % by weight of the polypropylene. The α-olefins can be ethylene or C₄ to C₁₀, or C₂₀ α-olefins. One, or two or more α-olefins can be copolymerized with propylene.

The weight average molecular weight (Mw) of the primary polypropylene can be within a range from 40,000, 50,000, or 80,000 g/mole to 200,000, 400,000, 500,000, or 1,000,000 g/mole. The number average molecular weight (Mn) can be within a range from 20,000, 30,000, or 40,000 g/mole to 50,000, 55,000, 60,000, or 70,000 g/mole. The z-average molecular weight (Mz) can be at least 300,000 or 350,000 g/mole, or within a range from 300,000 or 350,000 g/mole to 500,000 g/mole. The molecular weight distribution, Mw/Mn, in any embodiment can be less than 5.5, or 5, or 4.5, or 4, or within a range from 1.5, or 2, or 2.5, or 3 to 4, or 4.5 or 5 or 5.5.

The melt flow rate (MFR) of the primary polypropylene can be within a range from 1 to 500 dg/min, alternatively within a range from 1, or 5, or 10, or 15, or 20, or 25 dg/min to 45, or 55, or 100, or 300, or 350, or 400, or 450, or 500 dg/min, as measured per ASTM 1238, 2.16 kg at 230° C. The primary polypropylene can form thermoplastic blends including from 1 wt % to 95 wt % by weight of the blend of the polypropylene polymer component.

There is no particular limitation on the method for preparing the primary polypropylene of the invention. For example, the polymer may be a propylene homopolymer obtained by homopolymerization of propylene in a single stage or multiple stage reactor. Copolymers may be obtained by copolymerizing propylene and an ethylene and/or a C₄ to C₁₀, or C₂₀ α-olefin in a single stage or multiple stage reactor. Polymerization methods include high pressure, slurry, gas, bulk, or solution phase, or a combination thereof, using a traditional Ziegler-Natta catalyst or a single-site, metallocene catalyst system, or combinations thereof including bimetallic supported catalyst systems. Polymerization may be carried out by a continuous or batch process and may include use of chain transfer agents, scavengers, or other such additives as deemed applicable.

The primary polypropylene may be reactor grade, meaning that it has not undergone any post-reactor modification by reaction with peroxides, cross-linking agents, e− beam, gamma-radiation, or other types of controlled rheology modification. In any embodiment, the primary polypropylene can have been visbroken by peroxides as is known in the art.

Exemplary commercial products of the polypropylene polymers in primary polypropylene includes polypropylene homopolymer, random copolymer and impact copolymer produced by using Ziegler-Natta catalyst system have a broad Mw/Mn. An example of such product is ExxonMobil PP3155, a 36 dg/min homopolymer available from ExxonMobil Chemical Company, Baytown, Tex.

### Propylene-Based Elastomer

In any embodiment, the propylene-based elastomer is a random copolymer having crystalline regions interrupted by non-crystalline regions and within the range from 5 to 25 wt %, by weight of the propylene-based elastomer, of ethylene or C₄ to C₁₀ α-olefin derived units, and optionally diene-derived units, the remainder of the polymer being propylene-derived units. Not intended to be limited by any theory, it is believed that the non-crystalline regions may result from regions of non-crystallizable polypropylene segments and/or the inclusion of comonomer units. The crystallinity and the melting point of the propylene-based elastomer are reduced compared to highly isotactic polypropylene by the introduction of errors (stereo and region defects) in the insertion of propylene and/or by the presence of comonomer. The copolymer contains at least 60 wt % propylene-derived units by weight of the propylene-based elastomer. In any embodiment, the propylene-based elastomer can be a propylene-based elastomer having limited crystallinity due to adjacent isotactic propylene units and a melting point as described herein. In other embodiments, the propylene-based elastomer can be generally devoid of any substantial intermolecular heterogeneity in tacticity and comonomer composition, and also generally devoid of any substantial heterogeneity in intramolecular composition distribution.

The propylene-based elastomer can contain greater than 50 wt %, greater than 60 wt %, greater than 65 wt %, or greater than 75 wt % and up to 99 wt % propylene-derived units, based on the total weight of the propylene-based elastomer. In some embodiments, the propylene-based elastomer includes propylene-derived units in an amount based on the weight of propylene-based elastomer of from 75 wt % to 95 wt %, 75 wt % to 92.5 wt %, 82.5 wt % to 92.5 wt %, or 82.5 wt % to 90 wt %. Correspondingly, the units, or comonomers, derived from at least one of ethylene or a C₄ to C₁₀ α-olefin can be present in an amount of 5, or 10, or 14 wt % to 22, or 25 wt % by weight of the elastomer.

The comonomer content may be adjusted so that the propylene-based elastomer having a heat of fusion of 100 J/g or less, or 75 J/g or less, a melting point (Tm) of 100° C. or 90° C. or less, and crystallinity of 2% to 65% of isotactic polypropylene, and a melt flow rate (“MFR”), as measured at 230° C. and 2.16 kg weight, of less than 800 dg/min.

The propylene-based elastomer may comprise more than one comonomer. Preferred embodiments of a propylene-based elastomer have more than one comonomer including propylene-ethylene-octene, propylene-ethylene-hexene, and propylene-ethylene-butene copolymers.

In embodiments where more than one comonomers derived from at least one of ethylene or a C₄ to C₁₀ α-olefins are present, the amount of each comonomer may be less than 5 wt % of the propylene-based elastomer, but the combined amount of comonomers by weight of the propylene-based elastomer is 5 wt % or greater.

In some embodiments, the comonomer is ethylene, 1-hexene, or 1-octene. The comonomer can be present in an amount of 5, or 10, or 14 wt % to 22, or 25 wt % based on the weight of the propylene-based elastomer.

In any embodiment, the propylene-based elastomer can comprise ethylene-derived units. The propylene-based elastomer can comprise 5, 10, or 14 wt % to 22, or 25 wt % of ethylene-derived units by weight of the propylene-based elastomer. In any embodiment, the propylene-based elastomer can consist essentially of units derived from propylene and ethylene, i.e., the propylene-based elastomer does not contain any other comonomer in an amount typically present as impurities in the ethylene and/or propylene feedstreams used during polymerization or an amount that would materially affect the heat of fusion, melting point, crystallinity, or melt flow rate of the propylene-based elastomer, or any other comonomer intentionally added to the polymerization process.

In any embodiment, diene comonomer units can be included in the propylene-based elastomer. Examples of the diene include, but are not limited to, 5-ethylidene-2-norbornene, 5-vinyl-2-norbornene, divinylbenzene, 1,4-hexadiene, 5-methylene-2-norbornene, 1,6-octadiene, 5-methyl-1,4-hexadiene, 3,7-dimethyl-1,6-octadiene, 1,3-cyclopentadiene, 1,4-cyclohexadiene, dicyclopentadiene, or a combination thereof. The amount of diene comonomer can be equal to or more than 0 wt %, or 0.5 wt %, or 1 wt %, or 1.5 wt % and lower than, or equal to, 5 wt %, or 4 wt %, or 3 wt % or 2 wt % based on the weight of propylene-based elastomer.

The propylene-based elastomer has a heat of fusion (“Hf”), as determined by the Differential Scanning Calorimetry (“DSC”), of 100 J/g or less, or 75 J/g or less, 70 J/g or less, 50 J/g or less, or 35 J/g or less. The propylene-based elastomer can have a lower limit Hf of 0.5 J/g, 1 J/g, or 5 J/g. For example, the Hf value may be anywhere from 1.0, 1.5, 3.0, 4.0, 6.0, or 7.0 J/g, to 30, 35, 40, 50, 60, 70, or 75 J/g.

The propylene-based elastomer can have a percent crystallinity, as determined according to the DSC procedure described herein, of 2% to 65%, 0.5% to 40%, 1% to 30%, or 5% to 35%, of isotactic polypropylene. The thermal energy for the highest order of propylene (i.e., 100% crystallinity) is estimated at 189 J/g. In any embodiment, the copolymer has a crystallinity in the range of 0.25% to 25%, or 0.5% to 22% of isotactic polypropylene.

The propylene-based elastomer can have a triad tacticity of three propylene units (mmm tacticity), as measured by 13C NMR, of 75% or greater, 80% or greater, 85% or greater, 90% or greater, 92% or greater, 95% or greater, or 97% or greater. For example, the triad tacticity may range from about 75 to about 99%, from about 80 to about 99%, from about 85 to about 99%, from about 90 to about 99%, from about 90 to about 97%, or from about 80 to about 97%. Triad tacticity may be determined by the methods described in U.S. Pat. No. 7,232,871.

The propylene-based elastomer may have a tacticity index m/r ranging from a lower limit of 4 or 6 to an upper limit of 8 or 10 or 12. The tacticity index, expressed herein as “m/r”, is determined by 13C nuclear magnetic resonance (“NMR”). The tacticity index, m/r, is calculated as defined by H. N. Cheng in Vol. 17, MACROMOLECULES, pp. 1950-1955 (1984), incorporated herein by reference. The designation “m” or “r” describes the stereochemistry of pairs of contiguous propylene groups, “m” referring to meso, and “r” to racemic. An m/r ratio of 1.0 generally describes a syndiotactic polymer, and an m/r ratio of 2.0 describes an atactic material. The propylene-based elastomer can have a single peak melting transition as determined by DSC. In any embodiment, the copolymer has a primary peak transition of 90° C. or less, with a broad end-of-melt transition of 110° C. or greater. The peak “melting point” (“Tm”) is defined as the temperature of the greatest heat absorption within the range of melting of the sample. However, the copolymer may show secondary melting peaks adjacent to the principal peak, and/or at the end-of-melt transition. For the purposes of this disclosure, such secondary melting peaks are considered together as a single melting point, with the highest of these peaks being considered the Tm of the propylene-based elastomer. The propylene-based elastomer can have a Tm of 100° C. or less, 90° C. or less, 80° C. or less, or 70° C. or less. In any embodiment, the propylene-based elastomer can have a Tm of 25° C. to 100° C., 25° C. to 85° C., 25° C. to 75° C., or 25° C. to 65° C. In any embodiment, the propylene-based elastomer can have a Tm of 30° C. to 80° C. or 30° C. to 70° C.

For the thermal properties of the propylene-based elastomers, Differential Scanning Calorimetry (“DSC”) was used. Such DSC data was obtained using a Perkin-Elmer DSC 7.5 mg to 10 mg of a sheet of the polymer to be tested was pressed at approximately 200° C. to 230° C., then removed with a punch die and annealed at room temperature for 48 hours. The samples were then sealed in aluminum sample pans. The DSC data was recorded by first cooling the sample to −50° C. and then gradually heating it to 200° C. at a rate of 10° C./minute. The sample was kept at 200° C. for 5 minutes before a second cooling-heating cycle was applied. Both the first and second cycle thermal events were recorded. Areas under the melting curves were measured and used to determine the heat of fusion and the degree of crystallinity. The percent crystallinity (X %) was calculated using the formula, X %=[area under the curve (Joules/gram)/B(Joules/gram)]*100, where B is the heat of fusion for the homopolymer of the major monomer component. These values for B were found from the Polymer Handbook, Fourth Edition, published by John Wiley and Sons, New York 1999. A value of 189 J/g (B) was used as the heat of fusion for 100% crystalline polypropylene. The melting temperature was measured and reported during the second heating cycle (or second melt).

In one or more embodiments, the propylene-based elastomer can have a Mooney viscosity [ML (1+4) @ 125° C.], as determined according to ASTM D-1646, of less than 100, in other embodiments less than 75, in other embodiments less than 60, and in other embodiments less than 30.

The propylene-based elastomer can have a density of 0.850 g/cm3 to 0.920 g/cm3, 0.860 g/cm3 to 0.900 g/cm3, or 0.860 g/cm3 to 0.890 g/cm3, at room temperature as measured per ASTM D-1505.

The propylene-based elastomer can have a melt flow rate (“MFR”) greater than 0.5 dg/min, and less than or equal to 1,000 dg/min, or less than or equal to 800 dg/min, less than or equal to 500 dg/min, less than or equal to 200 dg/min, less than or equal to 100 dg/min, or less than or equal to 50 dg/min. Some embodiments can include a propylene-based elastomer with an MFR of less than or equal to 25 dg/min, such as from 1 to 25 dg/min or 1 to 20 dg/min The MFR is determined according to ASTM D-1238, condition L (2.16 kg, 230° C.).

The propylene-based elastomer can have a weight average molecular weight (“Mw”) of 5,000 to 5,000,000 g/mole, 10,000 to 1,000,000 g/mole, or 50,000 to 400,000 g/mole; a number average molecular weight (“Mn”) of 2,500 to 2,500,00 g/mole, 10,000 to 250,000 g/mole, or 25,000 to 200,000 g/mole; and/or a z-average molecular weight (“Mz”) of 10,000 to 7,000,000 g/mole, 80,000 to 700,000 g/mole, or 100,000 to 500,000 g/mole. The propylene-based elastomer can have a molecular weight distribution (Mw/Mn, or “MWD”) of 1.5 to 20, or 1.5 to 15, 1.5 to 5, 1.8 to 5, or 1.8 to 4.

The propylene-based elastomer can have an Elongation at Break of less than 2000%, less than 1000%, or less than 800%, as measured per ASTM D412.

The propylene-based elastomer can also include one or more dienes. The term “diene” is defined as a hydrocarbon compound that has two unsaturation sites, i.e., a compound having two double bonds connecting carbon atoms. Depending on the context, the term “diene” as used herein refers broadly to either a diene monomer prior to polymerization, e.g., forming part of the polymerization medium, or a diene monomer after polymerization has begun (also referred to as a diene monomer unit or a diene-derived unit). In some embodiments, the diene can be selected from 5-ethylidene-2-norbornene (ENB); 1,4-hexadiene; 5-methylene-2-norbornene (MNB); 1,6-octadiene; 5-methyl-1,4-hexadiene; 3,7-dimethyl-1,6-octadiene; 1,3-cyclopentadiene; 1,4-cyclohexadiene; vinyl norbornene (VNB); dicyclopentadiene (DCPD), and combinations thereof. In embodiments where the propylene-based elastomer composition comprises a diene, the diene can be present at from 0.05 wt % to about 6 wt %, from about 0.1 wt % to about 5.0 wt %, from about 0.25 wt % to about 3.0 wt %, from about 0.5 wt % to about 1.5 wt %, diene-derived units, where the percentage by weight is based upon the total weight of the propylene-derived, α-olefin derived, and diene-derived units.

The propylene-based elastomer can be grafted (i.e., “functionalized”) using one or more grafting monomers. As used herein, the term “grafting” denotes covalent bonding of the grafting monomer to a polymer chain of the propylene-based elastomer. The grafting monomer can be or include at least one ethylenically unsaturated carboxylic acid or acid derivative, such as an acid anhydride, ester, salt, amide, imide, or acrylates. Illustrative grafting monomers include, but are not limited to, acrylic acid, methacrylic acid, maleic acid, fumaric acid, itaconic acid, citraconic acid, mesaconic acid, maleic anhydride, 4-methyl cyclohexene-1,2-dicarboxylic acid anhydride, bicyclo(2.2.2)octene-2,3-dicarboxylic acid anhydride, 1,2,3,4,5,8,9,10-octahydronaphthalene-2,3-dicarboxylic acid anhydride, 2-oxa-1,3-diketospiro(4.4)nonene, bicyclo(2.2.1)heptene-2,3-dicarboxylic acid anhydride, maleopimaric acid, tetrahydrophthalic anhydride, norbornene-2,3-dicarboxylic acid anhydride, nadic anhydride, methyl nadic anhydride, himic anhydride, methyl himic anhydride, and 5-methylbicyclo(2.2.1)heptene-2,3-dicarboxylic acid anhydride. Other suitable grafting monomers include methyl acrylate and higher alkyl acrylates, methyl methacrylate and higher alkyl methacrylates, acrylic acid, methacrylic acid, hydroxy-methyl methacrylate, hydroxyl-ethyl methacrylate and higher hydroxy-alkyl methacrylates and glycidyl methacrylate. Maleic anhydride can be used as a grafting monomer. In embodiments where the graft monomer is maleic anhydride, the maleic anhydride concentration in the grafted polymer can be to about 6 wt %, at least about 0.5 wt %, or at least about 1.5 wt % based on the total weight of the propylene-based elastomer.

In some embodiments, the propylene-based elastomer can be a reactor blended polymer as defined herein. That is, the propylene-based elastomer is a reactor blend of a first polymer component and a second polymer component. Thus, the comonomer content of the propylene-based elastomer can be adjusted by adjusting the comonomer content of the first polymer component, adjusting the comonomer content of second polymer component, and/or adjusting the ratio of the first polymer component to the second polymer component present in the propylene-based elastomer.

In embodiments where the propylene-based elastomer is a reactor blended polymer, the α-olefin content of the first polymer component (“R1”) can be greater than 5 wt % α-olefin, greater than 7 wt % α-olefin, greater than 10 wt % α-olefin, greater than 12 wt % α-olefin, greater than 15 wt α-olefin, or greater than 17 wt α-olefin, where the percentage by weight is based upon the total weight of the propylene-derived and α-olefin-derived units of the first polymer component. The α-olefin content of the first polymer component can be less than 30 wt % α-olefin, less than 27 wt % α-olefin, less than 25 wt % α-olefin, less than 22 wt % α-olefin, less than 20 wt % α-olefin, or less than 19 wt % α-olefin, where the percentage by weight is based upon the total weight of the propylene-derived and α-olefin-derived units of the first polymer component. In some embodiments, the α-olefin content of the first polymer component can range from 5 wt % to 30 wt % α-olefin, from 7 wt % to 27 wt % α-olefin, from 10 wt % to 25 wt α-olefin, from 12 wt % to 22 wt α-olefin, from 15 wt % to 20 wt % α-olefin, or from 17 wt % to 19 wt % α-olefin. The first polymer component can comprise propylene and ethylene, and in some embodiments the first polymer component can consist only of propylene and ethylene derived units.

In embodiments where the propylene-based elastomer is a reactor blended polymer, the α-olefin content of the second polymer component (“R2”) can be greater than 1.0 wt % α-olefin, greater than 1.5 wt % α-olefin, greater than 2.0 wt % α-olefin, greater than 2.5 wt % α-olefin, greater than 2.75 wt % α-olefin, or greater than 3.0 wt % α-olefin, where the percentage by weight is based upon the total weight of the propylene-derived and α-olefin-derived units of the second polymer component. The α-olefin content of the second polymer component can be less than 10 wt % α-olefin, less than 9 wt % α-olefin, less than 8 wt % α-olefin, less than 7 wt % α-olefin, less than 6 wt % α-olefin, or less than 5 wt % α-olefin, where the percentage by weight is based upon the total weight of the propylene-derived and α-olefin-derived units of the second polymer component. In some embodiments, the α-olefin content of the second polymer component can range from 1.0 wt % to 10 wt α-olefin, or from 1.5 wt % to 9 wt % α-olefin, or from 2.0 wt % to 8 wt % α-olefin, or from 2.5 wt % to 7 wt % α-olefin, or from 2.75 wt % to 6 wt % α-olefin, or from 3 wt % to 5 wt % α-olefin. The second polymer component can comprise propylene and ethylene, and in some embodiments the first polymer component can consist only of propylene and ethylene derived units.

In embodiments where the propylene-based elastomer is a reactor blended polymer, the propylene-based elastomer can comprise from 1 to 25 wt % of the second polymer component, from 3 to 20 wt % of the second polymer component, from 5 to 18 wt % of the second polymer component, from 7 to 15 wt % of the second polymer component, or from 8 to 12 wt % of the second polymer component, based on the weight of the propylene-based elastomer. The propylene-based elastomer can comprise from 75 to 99 wt % of the first polymer component, from 80 to 97 wt % of the first polymer component, from 85 to 93 wt % of the first polymer component, or from 82 to 92 wt % of the first polymer component, based on the weight of the propylene-based elastomer.

The propylene-based elastomer can be prepared by any suitable means as known in the art. The propylene-based elastomer can be prepared using homogeneous conditions, such as a continuous solution polymerization process, using a metallocene catalyst. In some embodiments, the propylene-based elastomer can be prepared in parallel solution polymerization reactors, such that the first reactor component is prepared in a first reactor and the second reactor component is prepared in a second reactor, and the reactor effluent from the first and second reactors are combined and blended to form a single effluent from which the final propylene-based elastomer is separated. Exemplary methods for the preparation of propylene-based elastomers can be found in U.S. Pat. Nos. 6,881,800; 7,803,876; 8,013,069; and 8,026,323 and PCT Publications WO 2011/087729; WO 2011/087730; and WO 2011/087731.

Commercial examples of such propylene-based elastomers include Vistamaxx™ propylene-based elastomers from ExxonMobil Chemical Company, Tafmer™ elastomers from Mitsui Chemicals, and Versify™ elastomers from Dow Chemical Company.

### Polyalphaolefins

Polyalphaolefins (PAO) can comprise oligomers of α-olefins (also known as 1-olefins) and are often used as the base stock for synthetic lubricants. PAO can be produced by the polymerization of α-olefins, such as linear α-olefins. A PAO can be characterized by any type of tacticity, including isotactic or syndiotactic and/or atactic, and by any degree of tacticity, including isotactic-rich or syndiotactic-rich or fully atactic. PAO liquids are described in, for example, U.S. Pat. Nos. 3,149,178; 4,827,064; 4,827,073; 5,171,908; and 5,783,531; and in SYNTHETIC LUBRICANTS AND HIGH-PERFORMANCE FUNCTIONAL FLUIDS, Leslie R. Rudnick & Ronald L. Shubkin, eds. (Marcel Dekker, 1999), pp. 3-52. PAOs are Group 4 compounds, as defined by the American Petroleum Institute (API). The PAO can comprise C₂₀ to C₁₅₀₀ paraffins, C₄₀ to C₁₀₀₀ paraffins, C₅₀ to C₇₅₀ paraffins, or C₅₀ to C₅₀₀ paraffins. The PAO can be dimers, trimers, tetramers, pentamers, etc. of C₅ to C₁₄ α-olefins, and C₆ to C₁₂ α-olefins, or C₈ to C₁₂ α-olefins. Suitable olefins include 1-pentene, 1-hexene, 1-heptene, 1-octene, 1-nonene, 1-decene, 1-undecene and 1-dodecene. Exemplary PAO are described more particularly in, for example, U.S. Pat. Nos. 5,171,908, and 5,783,531 and in SYNTHETIC LUBRICANTS AND HIGH-PERFORMANCE FUNCTIONAL FLUIDS 1-52 (Leslie R. Rudnick & Ronald L. Shubkin, ed. Marcel Dekker, Inc. 1999), the entire contents of which are incorporated herein by reference.

PAO can be made by any suitable means known in the art. For example, the PAOs can be prepared by the oligomerization of an α-olefin in the presence of a polymerization catalyst, such as a Friedel-Crafts catalyst (including, for example, AlCl₃, BF₃, and complexes of BF₃ with water, alcohols, carboxylic acids, or esters), a coordination complex catalyst (including, for example, the ethylaluminum sesquichloride+TiCl4 system), or a homogeneous or heterogeneous (supported) catalyst more commonly used to make polyethylene and/or polypropylene (including, for example, Ziegler-Natta catalysts, metallocene or other single-site catalysts, and chromium catalysts). Subsequent to the polymerization, the PAO can be hydrogenated in order to reduce any residual unsaturation. PAO can be hydrogenated to yield substantially (>99 wt. %) paraffinic materials. The PAO can also be functionalized to comprise, for example, esters, polyethers, polyalkylene glycols, and the like.

PAO can possess a number average molecular weight (Mn) of from 100 to 21,000 in one embodiment, and from 200 to 10,000 in another embodiment, and from 200 to 7,000 in yet another embodiment, and from 200 to 2,000 in yet another embodiment, and from 200 to 500 in yet another embodiment.

The PAOs may have a weight average molecular weight (Mw) of less than 10,000 g/mol, or less than 5,000 g/mol, or less than 4,000 g/mol, or less than 2,000 g/mol, or less than 1,000 g/mol. In some embodiments, the PAO may have an Mw of 250 g/mol or more, 400 g/mol or more, or 500 g/mol or more, or 600 g/mol or more, or 700 g/mol or more, or 750 g/mol or more. In some embodiments, the PAO may have a Mw in the range of from 250 to 10,000 g/mol, or from 400 to 5,000 g/mol, or form 500 to 4,000 g/mol, or from 600 to 2000 g/mol, or from 700 to 1000 g/mol. The molecular weight of the PAO can be determined by GPC method using a column for medium to low molecular weight polymers, tetrahydrofuran as solvent and polystyrene as calibration standard, correlated with the fluid viscosity according to a power equation. Unless otherwise indicated Mw values reported herein are GPC values and are not calculated from kinematic viscosity at 100° C.

PAO can have a kinematic viscosity (“KV”) at 100° C., as measured by ASTM D445 at 100° C., of 3 cSt (1 cSt=1 mm2/s) to 3,000 cSt, 4 to 1,000 cSt, 6 to 300 cSt, 8 to 125 cSt, 8 to 100 cSt, or 10 to 60 cSt. In some embodiments, the PAO can have a KV at 100° C. of 5 to 1000 cSt, 6 to 300 cSt, 7 to 100 cSt, or 8 to 50 cSt.

PAO can also have a viscosity index (“VI”), as determined by ASTM D2270, of 50 to 400, or 60 to 350, or 70 to 250, or 80 to 200, or 90 to 175, or 100 to 150. PAO can have a viscosity index (“VI”), as determined by ASTM D2270, of greater than 100, 110, 120, 150, or 200.

PAO can have a pour point, as determined by ASTM D5950/D97, of −100° C. to 0° C., −100° C. to −10° C., −90° C. to −15° C., or −80° C. to −20° C. In some embodiments, the PAO or blend of PAO can have a pour point of −25 to −75° C. or −40 to −60° C.

PAO can have a flash point, as determined by ASTM D92, of 150° C. or more, 200° C. or more, 210° C. or more, 220° C. or more, 230° C. or more, or between 240° C. and 290° C.

The PAO can have a specific gravity (15.6/15.6° C., 1 atm/1 atm) of 0.79 to 0.90, 0.80 to 0.89, 0.81 to 0.88, 0.82 to 0.87, or 0.83 to 0.86.

PAO can have (a) a flash point of 200° C. or more, 210° C. or more, 220° C. or more, or 230° C. or more; and (b) a pour point less than −20° C., less than −25° C., less than −30° C., less than −35° C., or less than −40° C., and (c) a KV at 100° C. of 2 cSt or more, 4 cSt or more, 5 cSt or more, 6 cSt or more, 8 cSt or more.

PAO can have a KV at 100° C. of 5 to 50 cSt or 8 to 20 cSt; a pour point of −25 to −75° C. or −40 to −60° C.; and a specific gravity of 0.81 to 0.87 or 0.82 to 0.86.

Other useful PAO include those sold under the tradenames Synfluid™ available from ChevronPhillips Chemical Co. in Pasadena Tex., Durasyn™ available from BP Amoco Chemicals in London England, Nexbase™ available from Fortum Oil and Gas in Finland, Synton™ available from Crompton Corporation in Middlebury Conn., USA, EMERY™ available from Cognis Corporation in Ohio, USA.

The PAO can have a Kinematic viscosity of 10 cSt or more at 100° C., 30 cSt or more, 50 cSt or more, 80 cSt or more, 110 or more, 150 cSt or more, 200 cSt or more, 500 cSt or more, 750 or more, 1000 cSt or more, 1500 cSt or more, 2000 cSt or more, or 2500 or more. The PAO can have a kinematic viscosity at 100° C. of between 10 cSt and 3000 cSt, between 10 cSt and 1000 cSt, or between 10 cSt and 40 cSt.

The PAO can have a viscosity index of 120 or more, 130 or more, 140 or more, 150 or more, 170 or more, 190 or more, 200 or more, 250 or more, or 300 or more.

### Polymer Compositions

The Polymer compositions can comprise at least one polyalphaolefin (PAO), at least one propylene-based elastomer, and at least one primary propylene as previously described. In one or more embodiments, the primary propylene in the polymer composition can comprise from about 50 wt %, 60 wt %, 65 wt %, or 70 wt % of the polymer composition to about 75 wt %, 80 wt %, 85 wt %, 90 wt %, 95 wt %, or 98 wt % of the polymer composition. In one or more embodiments, the primary propylene in the polymer composition can comprise greater than about 70 wt %, 75 wt %, 80 wt %, 85 wt %, 90 wt %, 95 wt %, or 98 wt % of the polymer composition. In the same or other embodiments, the propylene-based elastomer in the polymer composition can comprise from about 1 wt %, 5 wt %, or 10 wt %, of the polymer composition to about 15 wt %, 20 wt %, 25 wt %, or 30 wt %, of the polymer composition. In one or more embodiments, the propylene-based elastomer in the polymer composition can comprise less than about 50 wt %, 35 wt %, 20 wt %, 15 wt %, 10 wt %, or 5 wt % of the polymer composition.

In the same or other embodiments, the PAO in the polymer composition can comprise from about 1 wt %, 5 wt %, or 10 wt %, of the polymer composition to about 15 wt %, 20 wt %, 25 wt %, or 30 wt %, of the polymer composition. In one or more embodiments, the PAO in the polymer composition can comprise less than about 50 wt %, 35 wt %, 20 wt %, 15 wt %, 10 wt %, or 5 wt % of the polymer composition. In some embodiments, only the weight of the PAO, propylene-based elastomer, and primary polypropylene are used to determine the weight of the polymer composition to determine the wt % described in this paragraph.

A variety of additives may be incorporated into the polymer compositions described herein, depending upon the intended purpose. For example, when the blends are used to form fibers and nonwoven fabrics, such additives may include but are not limited to stabilizers, antioxidants, fillers, colorants, nucleating agents, dispersing agents, mold release agents, slip additives, fire retardants, plasticizers, pigments, vulcanizing or curative agents, vulcanizing or curative accelerators, cure retarders, processing aids, tackifying resins, and the like. Other additives may include fillers and/or reinforcing materials, such as carbon black, clay, talc, calcium carbonate, mica, silica, silicate, combinations thereof, and the like. Primary and secondary antioxidants include, for example, hindered phenols, hindered amines, and phosphates. Nucleating agents include, for example, sodium benzoate and talc. Also, to improve crystallization rates, other nucleating agents may also be employed such as Ziegler-Natta olefin products or other highly crystalline polymers. Other additives such as dispersing agents, for example, Acrowax C, can also be included. Slip additives can include, for example, oleamide and erucamide. Catalyst deactivators are also commonly used, for example, calcium stearate, hydrotalcite, and calcium oxide, and/or other acid neutralizers known in the art. The additives can be present within a range from 0 wt %, 0.1 wt %, 0.2 wt %, 0.3 wt % to 1 wt %, 2, 3 wt %, or 4 wt %, or 5 wt % of additives by weight of the polymer composition. The slip additive can be used in an amount of less than 100 ppm, 50 ppm, 30 ppm, 10 ppm, or 1 ppm.

Further, in some exemplary embodiments, additives may be incorporated into the polymer compositions directly or as part of a masterbatch, i.e., an additive package containing several additives to be added at one time in predetermined proportions. In one or more embodiments herein, the fiber further comprises a masterbatch comprising a slip agent. The masterbatch may be added in any suitable amount to accomplish the desired result. For example, a masterbatch comprising a slip additive may be used in an amount ranging from about 0.1 to about 10 wt %, or from about 0.25 to about 7.5 wt %, or from about 0.5 to about 5 wt %, or from about 1 to about 5 wt %, or from about 2 to about 4 wt %, based on the total weight of the polymer composition and the masterbatch. In an embodiment, the masterbatch can comprises erucamide as the slip additive.

The polymer compositions can have a handle (grams) as measured by the Thwing-Albert Instruments Co. Handle-O-Meter (Model 211-10-B/AERGLA) of from about 1 g, 2 g, 3 g, 4 g, 5 g to about 7 g, 8 g, 9 g, 10 g, or 11 g. The polymer compositions can have a handle (grams) as measured by the Thwing-Albert Instruments Co. Handle-O-Meter (Model 211-10-B/AERGLA) of less than about 11 g, 10 g, 9 g, 8 g, or 7 g.

Fibers, Nonwoven Compositions, and Laminates Prepared from Polymer Compositions

In one or more embodiments, the polymer compositions described above can be meltspun (e.g., meltblown or spunbond) fibers and nonwoven compositions (e.g. fabrics). As used herein, “meltspun nonwoven composition” refers to a composition having at least one meltspun layer and does not require that the entire composition be meltspun or nonwoven. In some embodiments, the nonwoven compositions can additionally comprise one or more layers positioned on one or both sides of the nonwoven layer(s) comprising the PAO/propylene-based elastomer blend. As used herein, “nonwoven” refers to a textile material that has been produced by methods other than weaving. In nonwoven fabrics, the fibers can be processed directly into a planar sheet-like fabric structure and then either bonded chemically, thermally, or interlocked mechanically (or a combination thereof) to achieve a cohesive fabric.

In one or more embodiments, the process for forming nonwoven compositions can comprise the steps of forming a molten polymer composition comprising a blend of at least one PAO, at least one propylene-based elastomer, and at least one primary propylene as described above, and forming fibers comprising the polymer composition. The fibers can have a thickness from about 1 to about 10 denier, or from about 2 to about 8 denier, or from about 4 to about 6 denier. Although commonly referred to in the art and used herein for convenience as an indicator of thickness, denier is more accurately described as the linear mass density of a fiber. A denier is the mass (in grams) of a fiber per 9,000 meters. In practice, measuring 9,000 meters may be both time-consuming and wasteful. Usually, a sample of lesser length (i.e., 900 meters, 90 meters, or any other suitable length) is weighed and the result multiplied by the appropriate factor to obtain the denier of the fiber. The fibers can be monocomponent fibers or bicomponent fibers. A monocomponent fiber has a consistent composition throughout its cross-section.

In some embodiments, the methods can further comprise forming a nonwoven composition from the fibers. In further embodiments, the nonwoven composition formed from the polymer composition is employed as a facing layer, and the process may further comprise the steps of forming one or more nonwoven elastic layers and disposing the facing layer comprising the polymer composition upon the elastic layer. Optionally, two or more facing layers may be disposed upon the elastic layer or layers on opposite sides, such that the elastic layers are sandwiched between the facing layers. In one or more embodiments, the elastic layer or layers may comprise a propylene-based elastomer having the composition and properties described above. In certain embodiments, nonwoven compositions comprising the polymer composition can be described as extensible. “Extensible,” as used herein, means any fiber or nonwoven composition that yields or deforms (i.e., stretches) upon application of a force. While many extensible materials are also elastic, the term extensible also encompasses those materials that remain extended or deformed upon removal of the force. When an extensible facing layer is used in combination with an elastic core layer, desirable aesthetic properties may result because the extensible layer permanently deforms when the elastic layer to which it is attached stretches and retracts. This results in a wrinkled or textured outer surface with a soft feel that is particularly suited for articles in which the facing layer is in contact with a wearer's skin.

The fibers and nonwoven compositions can be formed by any method known in the art. For example, the nonwoven compositions can be produced by a meltblown or spunbond process. In certain embodiments herein, the layer or layers of the nonwoven compositions of the invention can be produced by a spunbond process. When the compositions further comprise one or more elastic layers, the elastic layers can be produced by a meltblown process, by a spunbond or spunlace process, or by any other suitable nonwoven process.

The nonwoven layer or layers described herein may be composed primarily of a polymer composition as described previously. In one or more embodiments, the nonwoven compositions can have a basis weight of from about 10 to about 75 g/m2 (“gsm”), or from about 15 to about 65 gsm, or from about 20 to about 55 gsm, or from about 22 to about 53 gsm, or from about 24 to about 51 gsm, or from about 25 to about 50 gsm. In the same or other embodiments, the nonwovens can have a tensile strength in the machine direction (MD) from about 5 to about 65 N/5 cm, or from about 7 to about 60 N/5 cm, or from about 10 to about 55 N/5 cm, or from about 10 to about 50 N/5 cm, or from about 15 to about 45 N/5 cm. Stated differently, the nonwovens can have an MD tensile strength greater than about 5 N/5 cm, or greater than about 10 N/5 cm, or greater than about 15 N/5 cm, or greater than about 20 N/5 cm. In the same or other embodiments, the nonwovens can have a tensile strength in the cross direction (CD) from about 5 to about 55 N/5 cm, or from about 7 to about 50 N/5 cm, or from about 10 to about 45 N/5 cm, or from about 10 to about 40 N/5 cm, or from about 15 to about 35 N/5 cm. Stated differently, the nonwovens can have an MD tensile strength greater than about 5 N/5 cm, or greater than about 10 N/5 cm, or greater than about 15 N/5 cm, or greater than about 20 N/5 cm.

In one or more embodiments, the nonwoven compositions can have a peak elongation in the machine direction (MD) greater than about 70%, or greater than about 75%, or greater than about 80%, or greater than about 85%, or greater than about 90%, or greater than about 95%, or greater than about 100%. In the same or other embodiments, the nonwoven compositions can have a peak elongation in the cross direction (CD) greater than about 80%, or greater than about 85%, or greater than about 90%, or greater than about 100%, or greater than about 105%, or greater than about 110%, or greater than about 115%, or greater than about 120%. Tensile strength and elongation are determined in accordance with ASTM D882.

As used herein, “meltblown fibers” and “meltblown compositions” (or “meltblown fabrics”) refer to fibers formed by extruding a molten thermoplastic material at a certain processing temperature through a plurality of fine, usually circular, die capillaries as molten threads or filaments into high velocity, usually hot, gas streams which attenuate the filaments of molten thermoplastic material to reduce their diameter, which may be to microfiber diameter. Thereafter, the meltblown fibers are carried by the high velocity gas stream and are deposited on a collecting surface to form a web or nonwoven fabric of randomly dispersed meltblown fibers. Such a process is generally described in, for example, U.S. Pat. Nos. 3,849,241 and 6,268,203. Meltblown fibers are microfibers that are either continuous or discontinuous, and, depending on the resin, may have a diameter smaller than about 10 microns (for example, for high MFR isotactic polypropylene resins such as PP3746G or Achieve™ 6936G1, available from ExxonMobil Chemical Company); whereas for certain resins (for example, Vistamaxx™ propylene-based elastomer, available from ExxonMobil Chemical Company) or certain high throughput processes such as those described herein, meltblown fibers may have diameters greater than 10 microns, such as from about 10 to about 30 microns, or about 10 to about 15 microns. The term meltblowing as used herein is meant to encompass the meltspray process.

Commercial meltblown processes that utilize extrusion systems can have a relatively high throughput, in excess of 0.3 grams per hole per minute (“ghm”), or in excess of 0.4 ghm, or in excess of 0.5 ghm, or in excess of 0.6 ghm, or in excess of 0.7 ghm. The nonwoven compositions can be produced using commercial meltblown processes, such as a high pressure meltblown process available from Biax-Fiberfilm Corporation, or in test or pilot scale processes. In one or more embodiments, the fibers used to form the nonwoven compositions can be formed using an extrusion system having a throughput rate of from about 0.01 to about 3.0 ghm, or from about 0.1 to about 2.0 ghm, or from about 0.3 to about 1.0 ghm

In a typical spunbond process, polymer is supplied to a heated extruder to melt and homogenize the polymers. The extruder supplies melted polymer to a spinneret where the polymer is fiberized as passed through fine openings arranged in one or more rows in the spinneret, forming a curtain of filaments. The filaments are usually quenched with air at a low temperature, drawn, usually pneumatically, and deposited on a moving mat, belt or “forming wire” to form the nonwoven composition. See, for example, in U.S. Pat. Nos. 4,340,563; 3,692,618; 3,802,817; 3,338,992; 3,341,394; 3,502,763; and 3,542,615. The term spunbond as used herein is meant to include spunlace processes, in which the filaments are entangled to form a web using high-speed jets of water (known as “hydroentanglement”).

The fibers produced in the spunbond process are usually in the range of from about 10 to about 50 microns in diameter, depending on process conditions and the desired end use for the fabrics to be produced from such fibers. For example, increasing the polymer molecular weight or decreasing the processing temperature results in larger diameter fibers. Changes in the quench air temperature and pneumatic draw pressure also have an effect on fiber diameter.

The nonwoven compositions described herein may be a single layer or may be multilayer laminates. One application is to make a laminate (or “composite”) from meltblown (“M”) and spunbond (“S”) nonwoven compositions, which combines the advantages of strength from the spunbonded component and greater barrier properties of the meltblown component. A typical laminate or composite has three or more layers, a meltblown layer(s) sandwiched between two or more spunbonded layers, or “SMS” nonwoven composites. Examples of other combinations are SSMMSS, SMMS, and SMMSS composites. Composites can also be made of the meltblown or spunbond nonwovens of the invention with other materials, either synthetic or natural, to produce useful articles.

In certain embodiments, the meltblown or spunbond nonwoven compositions of the invention comprise one or more elastic layers comprising a propylene-based elastomer and further comprise one or more facing layers comprising an ICP/propylene-based elastomer blend as described herein positioned on one or both sides of the elastic layer(s). In some embodiments, the elastic layers and the facing layers may be produced in a single integrated process, such as a continuous process. For example, a spunmelt process line can incorporate meltblown technology such that multilayer nonwoven laminates are produced that contain one or more meltblown elastic layers laminated to one or more other spunbond layers (which may be elastic or inelastic) in a single continuous integrated process.

The nonwoven products described above may be used in many articles such as hygiene products including, but not limited to, diapers, feminine care products, and adult incontinent products. The nonwoven products may also be used in medical products such as sterile wrap, isolation gowns, operating room gowns, surgical gowns, surgical drapes, first aid dressings, and other disposable items.

### EXAMPLES

The spunbonded nonwoven fabrics in Tables 1-4 below were produced on a Reicofil 4 (R4) line having a single spunbond (S) spinneret of about 1.1 m width, 5800-6300 holes with a hole (die) diameter of 0.6 mm. The Reicofil spunbonding process is described in more detail in EP 1340 843 or U.S. Pat. No. 6,918,750. Total throughput was about 200 kg/hour. The quench air temperature was 20° C. for all experiments. The ratio of the volume flow VM of process air to the monomer exhaust device to the process air with volume flow V1 escaping from the first upper cooling chamber section into a second lower cooling chamber section (VM/V1) was maintained in the range of from 0.1 to 0.3. Line speed was kept constant at approximately 205 m/min. The filaments were deposited continuously on a deposition web with a targeted fabric basis weight for all examples of 15 g/m² (gsm). Fabric basis weight defined as the mass of fabric per unit area was measured by weighing 3 12″×12″ fabric pieces and reporting an average value expressed in g/m² (gsm). Propylene polymer was delivered to the extruder from the main hopper. The Propylene polymer (PP) is a homopolymer available from ExxonMobil Chemical Company, Houston, Tex., under the tradename PP3155 (MFR of 35 dg/min). Propylene based elastomer (PBE), is available from ExxonMobil Chemical Company, Houston, Tex., under the tradename Vistamaxx™ 7020BF and was incorporated at the level identified. The polyalphaolefin (PAO) is available from ExxonMobil Chemical Company, Houston, Tex, under the tradename SpectraSyn 10. Slip additive was a masterbatch containing erucamide. The masterbatch was metered in to incorporate 2% of erucamide in all samples. It was obtained from Standridge Color Corporation of Georgia and identified as SCC-88953. Both the PBE and the slip additive from masterbatch were delivered to the extruder from additive feeders running at the appropriate feed rates. The PAO was introduced at the throat of the extruder using a Masterflex L/S Variable-Speed Drive with Remote I/O (600 rpm) pump available from Cole Palmer using a Masterflex L/S Easy-Load®II Head for Precision Tubing (PPS/SS) available from Cole Palmer. The pump was calibrated to deliver the required PAO (5, 10, 13.2%). The existing sight glass on the extruder was replaced with a plexiglass plate having an entry port to receive the required amount of PAO.

The formed fabric was thermally bonded by compressing it through a set of two heated rolls (calenders) for improving fabric integrity and improving fabric mechanical properties. Fundamentals of the fabric thermal bonding process can be found in the review paper by Michielson et al. “Review of Thermally Point-bonded Nonwovens: Materials, Processes, and Properties”, J. Applied Polym. Sci. Vol. 99, p. 2489-2496 (2005) or the paper by Bhat et al. “Thermal Bonding of Polypropylene Nonwovens: Effect of Bonding Variables on the Structure and Properties of the Fabrics”, J. Applied Polym. Sci., Vol. 92, p. 3593-3600 (2004). The two rolls are referred to as “embossing” and S rolls. In a typical trial, after establishing stable spinning conditions, the calender temperature was varied to create the bonding curve (i.e., tensile strength versus calender temperature). Bonding temperatures varied for the embossed roll from 140° to 155° C. and temperatures for the S roll varied from 137° to 152° degrees C. Spinnability of the inventive and comparison compositions was assessed to be excellent.

Tensile properties of nonwoven fabrics such as tensile strength in both machine (MD) and cross (CD) directions were measured according to standard method WSP 110.4 (05) with a gauge length of 200 mm and a testing speed of 100 mm/min, unless otherwise indicated. The width of the fabric specimen was 5 cm. For the tensile testing, an Instron machine was used (Model 5565) equipped with Instron Bluehill 2 (version 2.5) software for the data analysis.

Softness or “handle” as it is known in the art is measured using the Thwing-Albert Instruments Co. Handle-O-Meter (Model 211-10-B/AERGLA). The quality of “handle” is considered to be the combination of resistance due to the surface friction and flexibility of a fabric material. The Handle-O-Meter measures the above two factors using an LVDT (Linear Variable Differential Transformer) to detect the resistance that a blade encounters when forcing a specimen of material into a slot of parallel edges. A 3½ digit digital voltmeter (DVM) indicates the resistance directly in gram force. The “handle” of a given fabric is defined as the average of 8 readings taken on two fabric specimens (4 readings per specimen). For each test specimen (5 mm slot width), the handle is measured on both sides and both directions (MD and CD) and is recorded in grams. A decrease in “handle” indicates the improvement of fabric softness.

Coefficient of friction (COF) can decrease with increasing amounts of PBE. Decreasing values of COF indicate that the surface is more for silk-like or has less of a rubbery feeling. The coefficient of friction (COF) of a sheet or nonwoven product is a measure of the ability of the sheet to slide over itself or other surfaces. The TMI Monitor/Slip and Friction Tester, Model 32-06-00 was used to test the coefficient of starting friction (static friction) and the sliding friction (kinetic friction) between two sheet specimens or between a sheet specimen and an alternative substrate. The sled has the following dimensions, B-sled−2.5″×2.5″ 200±5 grams. The tester used a 0-1200 grams load cell.

The COF can be drastically altered by the use of additives. These additives sometimes bloom or exude to the surface making the sheet product more or less slippery. The blooming action may not always be uniform over the film surface. Those skilled in the art will appreciate that the value can be affected by the amount of slip additive incorporated. COF is dependent on the rate of motion between two surfaces. Care must be exercised to ensure that the rate of motion of the equipment is controlled. Since COF is a surface phenomenon, films produced by different processes, or under different conditions may give different results. These factors must be considered when evaluating the results.

TABLE 1

| | | | Slip | Bonding | | | |
|---|---|---|---|---|---|---|---|
| PBE | PAO | PP | Additive | Temperature | Static | Kinetic | Handle |
| % | % | % | (ppm) | ° C. | COF | COF | (grams) |
| 0 | 0 | 0 | 0 | 145 | 0.50 | 0.37 | 12.2 |
| 5 | 0 | 95 | 0 | 145 | 0.45 | 0.36 | 11.9 |
| 5 | 5 | 90 | 0 | 145 | 0.47 | 0.36 | 6.5 |
| 5 | 10 | 85 | 0 | 145 | 0.51 | 0.42 | 4.7 |
| 5 | 13.2 | 81.8 | 0 | 145 | 0.52 | 0.38 | 4.4 |
| 10 | 0 | 90 | 0 | 145 | 0.52 | 0.44 | 10.0 |
| 10 | 5 | 85 | 0 | 145 | 0.60 | 0.53 | 6.3 |
| 10 | 10 | 80 | 0 | 145 | 0.47 | 0.36 | 4.3 |
| 10 | 13.2 | 76.8 | 0 | 145 | 0.49 | 0.39 | 4.1 |
| 15 | 0 | 85 | 0 | 145 | 0.52 | 0.41 | 9.6 |
| 15 | 5 | 80 | 0 | 145 | 0.70 | 0.61 | 5.7 |
| 15 | 10 | 75 | 0 | 145 | 0.48 | 0.39 | 4.3 |
| 15 | 13.2 | 71.8 | 0 | 145 | 0.47 | 0.37 | 4.4 |

TABLE 2

| | | | Slip | Bonding | | | |
|---|---|---|---|---|---|---|---|
| PBE | PAO | PP | Additive | Temperature | Static | Kinetic | Handle |
| % | % | % | (ppm) | ° C. | COF | COF | (grams) |
| 0 | 0 | 0 | 0 | 150 | 0.48 | 0.41 | 13.3 |
| 5 | 0 | 95 | 0 | 150 | 0.43 | 0.35 | 12.4 |
| 5 | 5 | 90 | 0 | 150 | 0.31 | 0.24 | 7.3 |
| 5 | 10 | 85 | 0 | 150 | 0.38 | 0.31 | 4.8 |
| 5 | 13.2 | 81.8 | 0 | 150 | 0.43 | 0.34 | 4.7 |
| 10 | 0 | 90 | 0 | 150 | 0.50 | 0.43 | 11.3 |
| 10 | 5 | 85 | 0 | 150 | 0.59 | 0.52 | 8.0 |
| 10 | 10 | 80 | 0 | 150 | 0.37 | 0.30 | 5.2 |
| 10 | 13.2 | 76.8 | 0 | 150 | 0.51 | 0.38 | 4.7 |
| 15 | 0 | 85 | 0 | 150 | 0.52 | 0.44 | 10.7 |
| 15 | 5 | 80 | 0 | 150 | 0.68 | 0.57 | 8.0 |
| 15 | 10 | 75 | 0 | 150 | 0.47 | 0.37 | 5.6 |
| 15 | 13.2 | 71.8 | 0 | 150 | 0.46 | 0.37 | 4.6 |

TABLE 3

| | | | Slip | Bonding | | | |
|---|---|---|---|---|---|---|---|
| PBE | PAO | PP | Additive | Temperature | Static | Kinetic | Handle |
| % | % | % | (ppm) | ° C. | COF | COF | (grams) |
| 0 | 0 | 0 | 2000 | 145 | 0.43 | 0.29 | 10.4 |
| 5 | 0 | 93 | 2000 | 145 | 0.39 | 0.28 | 9.4 |
| 5 | 5 | 88 | 2000 | 145 | 0.32 | 0.24 | 7.1 |
| 5 | 10 | 83 | 2000 | 145 | 0.40 | 0.31 | 4.6 |
| 5 | 13.2 | 79.8 | 2000 | 145 | 0.40 | 0.33 | 4.3 |
| 10 | 0 | 88 | 2000 | 145 | 0.40 | 0.26 | 8.7 |
| 10 | 5 | 83 | 2000 | 145 | 0.30 | 0.22 | 7.0 |
| 10 | 10 | 78 | 2000 | 145 | 0.39 | 0.32 | 5.0 |
| 10 | 13.2 | 74.8 | 2000 | 145 | 0.43 | 0.36 | 3.6 |
| 15 | 0 | 83 | 2000 | 145 | 0.36 | 0.27 | 7.8 |
| 15 | 5 | 78 | 2000 | 145 | 0.34 | 0.24 | 6.0 |
| 15 | 10 | 73 | 2000 | 145 | 0.41 | 0.34 | 4.2 |
| 15 | 13.2 | 69.8 | 2000 | 145 | 0.44 | 0.36 | 3.5 |

TABLE 4

| | | | Slip | Bonding | | | |
|---|---|---|---|---|---|---|---|
| PBE | PAO | PP | Additive | Temperature | Static | Kinetic | Handle |
| % | % | % | (ppm) | ° C. | COF | COF | (grams) |
| 0 | 0 | 0 | 2000 | 150 | 0.40 | 0.28 | 11.4 |
| 5 | 0 | 93 | 2000 | 150 | 0.41 | 0.27 | 9.6 |
| 5 | 5 | 88 | 2000 | 150 | 0.55 | 0.47 | 6.6 |
| 5 | 10 | 83 | 2000 | 150 | 0.47 | 0.36 | 5.6 |
| 5 | 13.2 | 79.8 | 2000 | 150 | 0.51 | 0.38 | 4.5 |
| 10 | 0 | 88 | 2000 | 150 | 0.35 | 0.25 | 8.8 |
| 10 | 5 | 83 | 2000 | 150 | 0.32 | 0.25 | 5.9 |
| 10 | 10 | 78 | 2000 | 150 | 0.47 | 0.36 | 4.9 |
| 10 | 13.2 | 74.8 | 2000 | 150 | 0.45 | 0.36 | 4.3 |
| 15 | 0 | 83 | 2000 | 150 | 0.36 | 0.25 | 8.3 |
| 15 | 5 | 78 | 2000 | 150 | 0.32 | 0.24 | 6.4 |
| 15 | 10 | 73 | 2000 | 150 | 0.34 | 0.25 | 6.4 |
| 15 | 13.2 | 69.8 | 2000 | 150 | 0.35 | 0.26 | 3.5 |

Embodiments of the present disclosure further relate to any one or more of the following paragraphs.

A fiber comprising: at least one primary polypropylene, at least one polyalphaolefin, and at least one propylene-based elastomer having a heat of fusion less than about 80 J/g, wherein the propylene-based elastomer comprises greater than 50 wt % propylene and from about 3 to about 25 wt % units derived from one or more C2 or C4-C12 α-olefins, based on a total weight of the propylene-based elastomer.

A fiber comprising: 50 wt % to 98 wt % of a primary polypropylene, 1 wt % to 20 wt % of a polyalphaolefin, and 1 wt % to 20 wt % of a propylene-based elastomer based on the combined weights of the primary polypropylene, the polyalphaolefin, and the propylene-based elastomer, wherein the propylene-based elastomer has a triad tacticity greater than about 90% and a heat of fusion less than about 80 J/g and comprises propylene and from about 3 to about 25 wt % units derived from one or more C₂ or C₄-C₁₂ α-olefins based on weight of the propylene-based elastomer.

The fiber according to any one or more of the preceding paragraphs, wherein the fiber comprises 50 wt % to 98 wt % of the primary polypropylene based on a combined weight of the primary polypropylene, the polyalphaolefin, and the propylene-based elastomer.

The fiber according to any one or more of the preceding paragraphs, wherein the primary polypropylene is produced by using a Ziegler-Natta catalyst system.

The fiber according to any one or more of the preceding paragraphs, wherein the primary polypropylene has a Mw/Mn within a range from 3 to 4.5, as determined by GPC.

The fiber according to any one or more of the preceding paragraphs, wherein the primary polypropylene has a melt flow rate of 10 dg/min to 250 dg/min, as determined in accordance with ASTM 1238, 2.16 kg at 230° C.

The fiber according to any one or more of the preceding paragraphs, wherein the fiber comprises 1 wt % to 20 wt % of the propylene-based elastomer based on a combined weight of the primary polypropylene, the polyalphaolefin, and the propylene-based elastomer.

The fiber according to any one or more of the preceding paragraphs, wherein the propylene-based elastomer has a triad tacticity greater than about 90%, as measured by 13C NMR.

The fiber according to any one or more of the preceding paragraphs, where the propylene-based elastomer is a reactor blend of a first polymer component and a second polymer component.

The fiber according to any one or more of the preceding paragraphs, where the first polymer component comprises propylene and ethylene and has an ethylene content of greater than 10 wt %, based on a total weight of the first polymer component.

The fiber according to any one or more of the preceding paragraphs, where the second polymer component comprises propylene and ethylene and has an ethylene content of greater than 2 wt %, based on a total weight of the second polymer component.

The fiber according to any one or more of the preceding paragraphs, wherein the fiber comprises 1 wt % to 20 wt % of the polyalphaolefin based on a combined weight of the primary polypropylene, the polyalphaolefin, and the propylene-based elastomer.

The fiber according to any one or more of the preceding paragraphs, wherein the polyalphaolefin has a viscosity index of at least 120.

The fiber according to any one or more of the preceding paragraphs, further comprising a slip additive.

The fiber according to any one or more of the preceding paragraphs, wherein the fiber comprises less than 50 ppm of a slip additive.

The fiber according to any one or more of the preceding paragraphs, wherein the handle is less than 9 g as measured using a Thwing-Albert Instruments Co. Handle-O-Meter Model 211-10-B/AERGLA.

The fiber according to any one or more of the preceding paragraphs, wherein the handle is less than 7 g as measured using a Thwing-Albert Instruments Co. Handle-O-Meter Model 211-10-B/AERGLA.

An article comprising the fibers of any one or more of the preceding paragraphs.

The article of the preceding paragraph, wherein the article comprises personal care products, baby diapers, training pants, absorbent underpads, swim wear, wipes, feminine hygiene products, bandages, wound care products, medical garments, surgical gowns, filters, adult incontinence products, surgical drapes, coverings, garments, cleaning articles and apparatus.

A nonwoven composition comprising the fibers of any one or more of the preceding paragraphs.

A nonwoven comprising: 50 wt % to 98 wt % of a primary polypropylene, 1 wt % to 20 wt % of a polyalphaolefin, and 1 wt % to 20 wt % of a propylene-based elastomer based on the combined weights of the primary polypropylene, the polyalphaolefin, and the propylene-based elastomer, wherein the propylene-based elastomer has a triad tacticity greater than about 90% and a heat of fusion less than about 80 J/g and comprises propylene and from about 3 to about 25 wt % units derived from one or more C2 or C4-C12 α-olefins based on weight of the propylene-based elastomer.

The nonwoven composition of any one or more of the preceding paragraphs, wherein the nonwoven composition is spunbound.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to certain embodiments, other and further embodiments may be devised without departing from the basic scope thereof, and the scope thereof is determined by the claims that follow.

What is claimed is:

1. A fiber comprising:
at least one primary polypropylene,
at least one polyalphaolefin, and
at least one propylene-based elastomer having a heat of fusion less than about 80 J/g, wherein the propylene-based elastomer comprises greater than 50 wt % propylene and from about 3 to about 25 wt % units derived from one or more C₂ or C₄-C₁₂ α-olefins, based on a total weight of the propylene-based elastomer.

2. The fiber of claim 1, wherein the fiber comprises 50 wt % to 98 wt % of the primary polypropylene based on a combined weight of the primary polypropylene, the polyalphaolefin, and the propylene-based elastomer.

3. The fiber of claim 1, wherein the primary polypropylene is produced by using a Ziegler-Natta catalyst system.

4. The fiber of claim 1, wherein the primary polypropylene has a Mw/Mn within a range from 3 to 4.5, as determined by GPC.

5. The fiber of claim 1, wherein the primary polypropylene has a melt flow rate of 10 dg/min to 250 dg/min, as determined in accordance with ASTM 1238, 2.16 kg at 230° C.

6. The fiber of claim 1, wherein the fiber comprises 1 wt % to 20 wt % of the propylene-based elastomer based on a combined weight of the primary polypropylene, the polyalphaolefin, and the propylene-based elastomer.

7. The fiber of claim 1, wherein the propylene-based elastomer has a triad tacticity greater than about 90%, as measured by 13C NMR.

8. The fiber of claim 1, where the propylene-based elastomer is a reactor blend of a first polymer component and a second polymer component.

9. The fiber of claim 8, where the first polymer component comprises propylene and ethylene and has an ethylene content of greater than 10 wt %, based on a total weight of the first polymer component.

10. The fiber of claim 8, where the second polymer component comprises propylene and ethylene and has an ethylene content of greater than 2 wt %, based on a total weight of the second polymer component.

11. The fiber of claim 1, wherein the fiber comprises 1 wt % to 20 wt % of the polyalphaolefin based on a combined weight of the primary polypropylene, the polyalphaolefin, and the propylene-based elastomer.

12. The fiber of claim 1, wherein the polyalphaolefin has a viscosity index of at least 120.

13. The fiber of claim 1, further comprising a slip additive.

14. The fiber of claim 1, wherein the fiber comprises less than 50 ppm of a slip additive.

15. The fiber of claim 1, wherein the handle is less than 9 g as measured using a Thwing-Albert Instruments Co. Handle-O-Meter Model 211-10-B/AERGLA.

16. The fiber of claim 1, wherein the handle is less than 7 g as measured using a Thwing-Albert Instruments Co. Handle-O-Meter Model 211-10-B/AERGLA.

17. An article comprising the fiber of claim 1.

18. The article of claim 17, wherein the article comprises personal care products, baby diapers, training pants, absorbent underpads, swim wear, wipes, feminine hygiene products, bandages, wound care products, medical garments, surgical gowns, filters, adult incontinence products, surgical drapes, coverings, garments, cleaning articles and apparatus.

19. A nonwoven composition comprising the fibers of claim 1.

20. The nonwoven composition of claim 19, wherein the nonwoven composition is spunbound.

21. A fiber comprising:
50 wt % to 98 wt % of a primary polypropylene, 1 wt % to 20 wt % of a polyalphaolefin, and 1 wt % to 20 wt % of a propylene-based elastomer based on the combined weights of the primary polypropylene, the polyalphaolefin, and the propylene-based elastomer,
wherein the propylene-based elastomer has a triad tacticity greater than about 90% and a heat of fusion less than about 80 J/g and comprises propylene and from about 3 to about 25 wt % units derived from one or more C₂ or C₄-C₁₂ α-olefins based on weight of the propylene-based elastomer.

22. A nonwoven comprising:
50 wt % to 98 wt % of a primary polypropylene, 1 wt % to 20 wt % of a polyalphaolefin, and 1 wt % to 20 wt % of a propylene-based elastomer based on the combined weights of the primary polypropylene, the polyalphaolefin, and the propylene-based elastomer,
wherein the propylene-based elastomer has a triad tacticity greater than about 90% and a heat of fusion less than about 80 J/g and comprises propylene and from about 3 to about 25 wt % units derived from one or more C₂ or C₄-C₁₂ α-olefins based on weight of the propylene-based elastomer.
